(19) United States
(12) Patent Application Publication
(10) Pub. No.: US 2011/0148120 A1
(43) Pub. Date: Jun. 23, 2011

(54) WIND-POWERED DEVICE

(76) Inventor: Fu-Chang Liao, Toufen Chen (TW)

(21) Appl. No.: 12/753,629

(22) Filed: Apr. 2, 2010

(30) Foreign Application Priority Data
Dec. 22, 2009 (TW) 098144357
Mar. 3, 2010 (TW) 099106111

(51) Int. Cl. F03D 9/00

(52) U.S. Cl. 290/55

(57) ABSTRACT

A side-blown wind-powered device has at least one blade driven by the wind power and moving along a track. With the movement of the blade, the wind power can be efficiently transferred into a mechanical power to drive electrical devices or generate electrical power with generating devices.

### BACKGROUND OF THE INVENTION

1. Field of the Invention

The present invention relates to a wind-powered device, and more particularly to a side-blown wind-powered device that can transfer wind power into a mechanical power efficiently for driving electrical devices or generating electrical power.

2. Description of Related Art

A conventional wind-powered generator comprises multiple blades driven by wind power and connected to an electrical generating device with a driving rod. With the rotation of the blades driven by wind power, the generating device can generate electrical power that is an environment friendly power source.

The inventor of the present invention has invented and filed several patents/applications referring to wind-powered devices, such as TW Utility Model No. 301942, TW Patent application No. 96115221 and TW Patent application No. 98118349 to improve the efficiency of transferring wind power into mechanical power. The present invention provides a side-blown wind-powered device to transfer wind power into a mechanical power efficiently.

### SUMMARY OF THE INVENTION

The main objective of the invention is to provide a side-blown wind-powered device to transfer wind power into a mechanical power efficiently.

To achieve the objective, the invention provides wind-powered device comprises at least one endless driving device, at least one blade and at least one chain assembly. The at least one endless driving device has a longitudinal direction, and at least one blade is connected to the at least one driving device. The at least one chain assembly is mounted parallelly to the longitudinal direction of the at least one endless driving device. Each chain assembly has an endless chain detachably connected to and driven by the at least one blade. Accordingly, the at least one endless driving device and the chain of the at least one chain assembly are driven by the at least one blade with wind power to transfer the wind power into a mechanical power and connected with a generating device.

To achieve the objective, the invention further provides wind-powered device comprises at least one endless driving device, at least one blade and at least one wheel track. The at least one endless driving device has a longitudinal direction, and at least one blade is connected to the at least one driving device. Each blade has multiple rotating wheels mounted on a position away from a conjunction between the blade and the at least one driving device. The at least one wheel track is mounted parallelly to the longitudinal direction of the at least one endless driving device and abuts with the wheels on the blades. Accordingly, the at least one endless driving device is driven by the at least one blade with wind power to transfer the wind power into a mechanical power and connected with a generating device.

To achieve the objective, the invention further provides wind-powered device comprises at least one endless driving device, at least one blade and at least one wheel track. The at least one endless driving device has a longitudinal direction, and at least one blade is connected to the at least one driving device. Each blade has a wheel assembly mounted on a position away from a conjunction between the blade and the at least one driving device, and each wheel assembly has a rotating wheel. The at least one wheel track is mounted parallelly to the longitudinal direction of the at least one endless driving device on a path of the wheel assemblies on the blades and holding the rotating wheels of the wheel assemblies on the blades rotatably inside. Accordingly, the at least one endless driving device is driven by the at least one blade with wind power to transfer the wind power into a mechanical power and connected with a generating device.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a wind-powered device in accordance with the present invention;

FIG. 2 is an exploded perspective view of the wind-powered device in FIG. 1;

FIG. 3 is a partially exploded perspective view of the wind-powered device in FIG. 2;

FIG. 4 is an exploded perspective view of a chain assembly of the wind-powered device;

FIG. 4A is an enlarged perspective of chain units of the chain assembly in FIG. 4;

FIG. 5 is an operational side view of the wind-powered device in FIG. 1 showing the blades are pushed to move with wind;

FIG. 6 is an operational side view of the wind-powered device in FIG. 1 showing the blades are pushed to a horizontal condition when the wind power is over a desired level;

FIG. 7 is an exploded perspective view of the rotating wheel, the wheel mount and the supporting panel of the wind-powered device in FIG. 1;

FIG. 8 is a perspective view of a second embodiment of a wind-powered device in accordance with the present invention;

FIG. 9 is an enlarged partial perspective view of the wind-powered device in FIG. 8;

FIG. 10 is an enlarged perspective view of the blade, the driving device and the chain assembly of the wind-powered device in FIG. 1;

FIG. 10A is an enlarged perspective of a connector of the wind-powered device in FIG. 10;

FIG. 11 is an exploded partial perspective of a third embodiment of a wind-powered device in accordance with the present invention;

FIG. 12 is an exploded perspective view of the wind-powered device in FIG. 11; and

FIG. 13 is an operational perspective of the wind-powered device in FIG. 12.

### DETAILED DESCRIPTION OF PREFERRED EMBODIMENT

A side-blown wind-powered device in accordance with the present invention comprises at least one endless driving device, at least one blade and at least one chain assembly. The at least one endless driving device has a longitudinal direction, and at least one blade is connected to the at least one driving device. The at least one chain assembly is mounted parallelly to the longitudinal direction of the at least one endless driving device, and each one of the at least one chain assembly having an endless chain detachably connected to and driven by the at least one blade. Accordingly, the at least one endless driving device and the chain of the at least one chain assembly are driven by the at least one blade with wind power to transfer the wind power into a mechanical power and connected with a generating device.

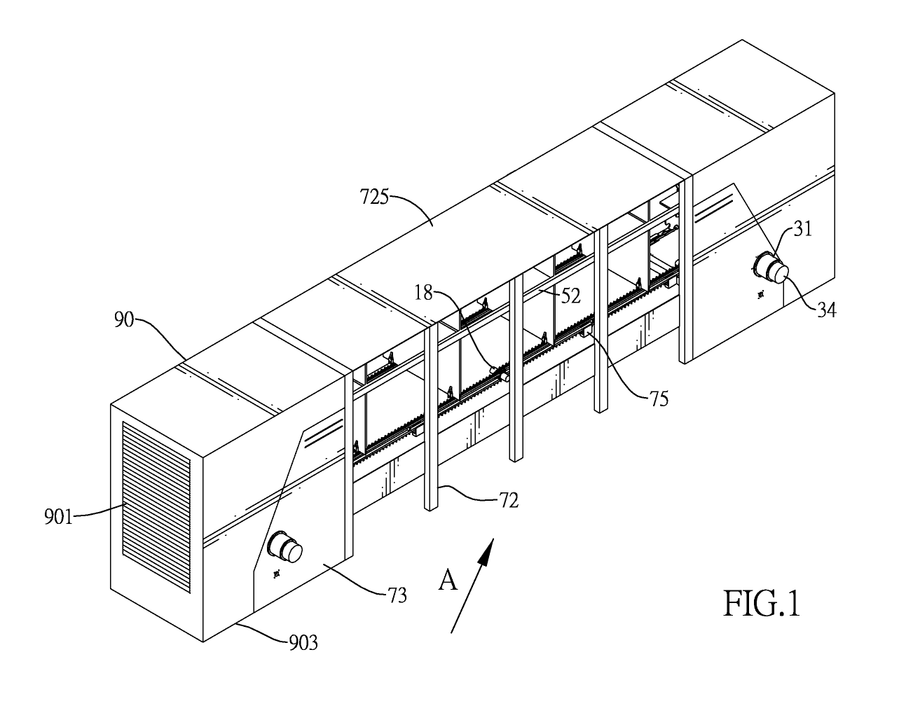

With reference to FIGS. 1 to 4, the wind-powered device in accordance with the present invention comprises a base, two endless driving devices, two chain assemblies (17), multiple blades (20), a fence assembly, two turbulent flow chambers (90) and multiple generating devices.

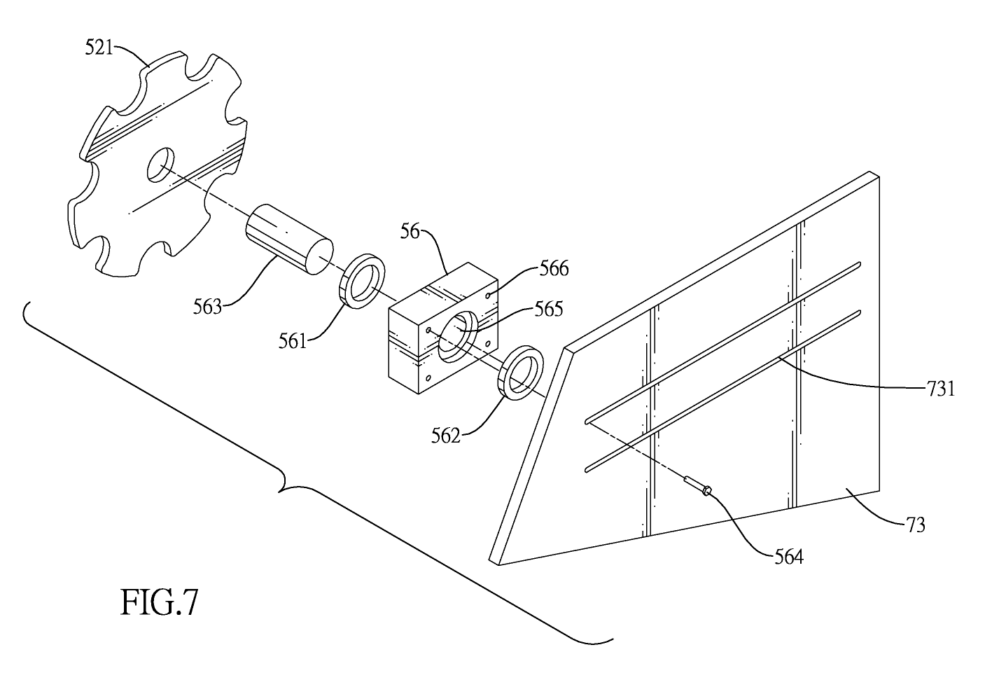

The base may be composed of multiple tubular members or structural steels and comprises a longitudinal direction, multiple doorframes (72) separately arranged along the longitudinal direction, multiple sliding brackets (75) and four supporting panels (73). Each doorframe (72) comprises two parallel side rods, a top lateral rod mounted on and connected between tops of the parallel side rods, and a bottom lateral rod (722) mounted on and connected between middles of the parallel side rods. The sliding brackets (75) are slidably mounted on the doorframes (72) with driving apparatuses, such as cylinders, slider-threaded rod assemblies or the like to move the sliding brackets (75) along the parallel side rods of the doorframes (72). With further reference to FIG. 7, the supporting panels (73) are mounted on the side rods of the doorframes (72) that are at two ends of the base and are arranged in parallel to each other. Each supporting panel (73) has two slots (731) and a wheel mount (56). The slots (731) are defined through the supporting panel (73), are parallel to each other and are respectively aligned with the slots (731) in the corresponding supporting panel (73) that is mounted on a same doorframe (72). The wheel mount (56) is mounted on the supporting panel (73) at a side facing to the corresponding supporting panel (73), may be cubic and comprises an axle hole (565), an axle (563), two bearings (561,562) and multiple mounting holes (566). The axle hole (565) is defined through the wheel mount (56), and the axle (563) is mounted rotatably through the axle hole (565) with the bearings (561,562) held respectively in two ends of the axle hole (565). The mounting holes (566) are defined in the wheel mount (56), may be threaded and align respectively with the slots (731) in the supporting panel (73). Multiple fasteners (564) are mounted through the slots (73) and screwed respectively into the threaded holes (566) to combine the wheel mount (56) securely with the supporting panel (73).

The driving devices are mounted on the base and may be mounted in spaces defined between the side rods and lateral rods (722) of the doorframes (72), and each comprises a longitudinal direction, an upper track (52), a lower track (53), multiple driving wheels (311,521) and an endless driving element (50). The longitudinal direction of the driving device is parallel to that of the base. The tracks (52,53) are mounted on the side rods of the doorframes (72) along the longitudinal direction of the driving device and are parallel to each other. Each track (52,53) has a channel defined in and along the track (52,53). The driving wheels (311,521) are respectively mounted around the axles (563) of the wheel mounts (56) on the supporting panels (73) and correspond respectively to the tracks (52,53).

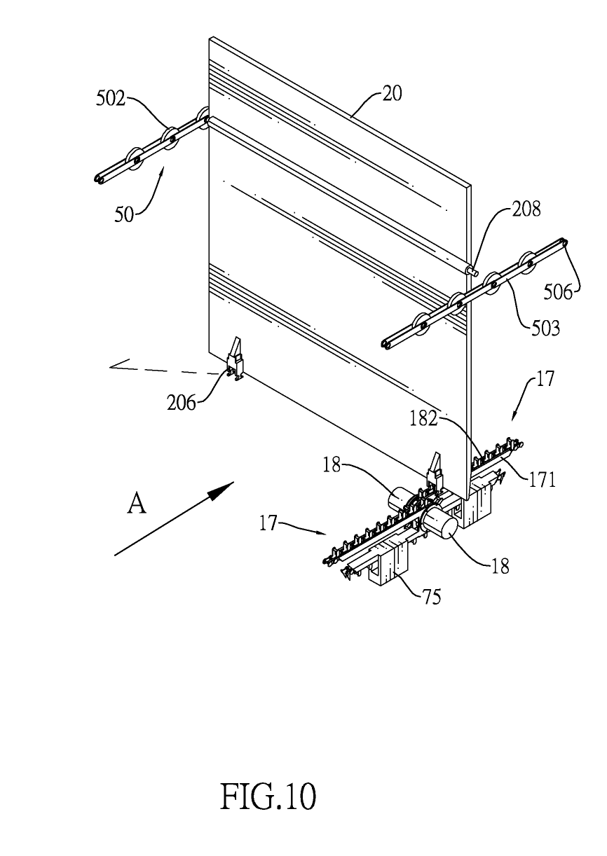

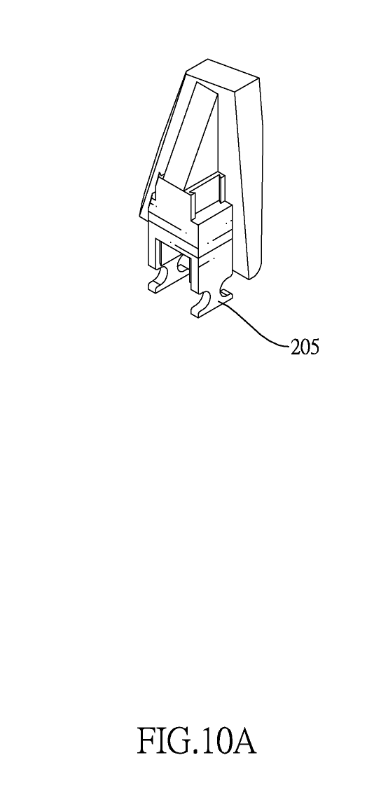

The driving element (50) is mounted around and engages the driving wheels (311,521) and mounted slidably in the channels in the upper and lower tracks (52,53). The driving element (50) can be a belt, a chain or the like to drive the driving wheels (311,521) rotating when the driving element (50) moves endlessly. With further reference to FIGS. 10 and 10A, the driving element (50) comprises multiple chain units connected each other to form as a chain. Each chain unit composed of two chain tabs (503) parallel to each other and has two pivot holes (506) defined respectively in two ends of the chain unit. With pivots being mounted through the pivot holes (506) of the chain units, the chain units are connected each other to form as the chain-typed driving element (50). Additionally, a rotator (502) is mounted between each pair of adjacent chain units.

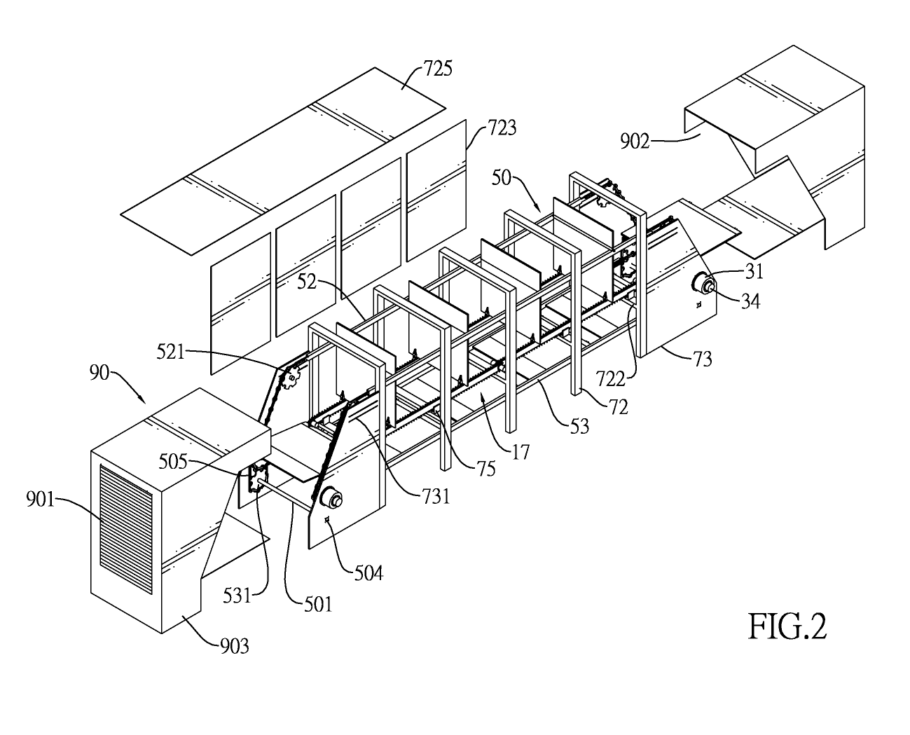

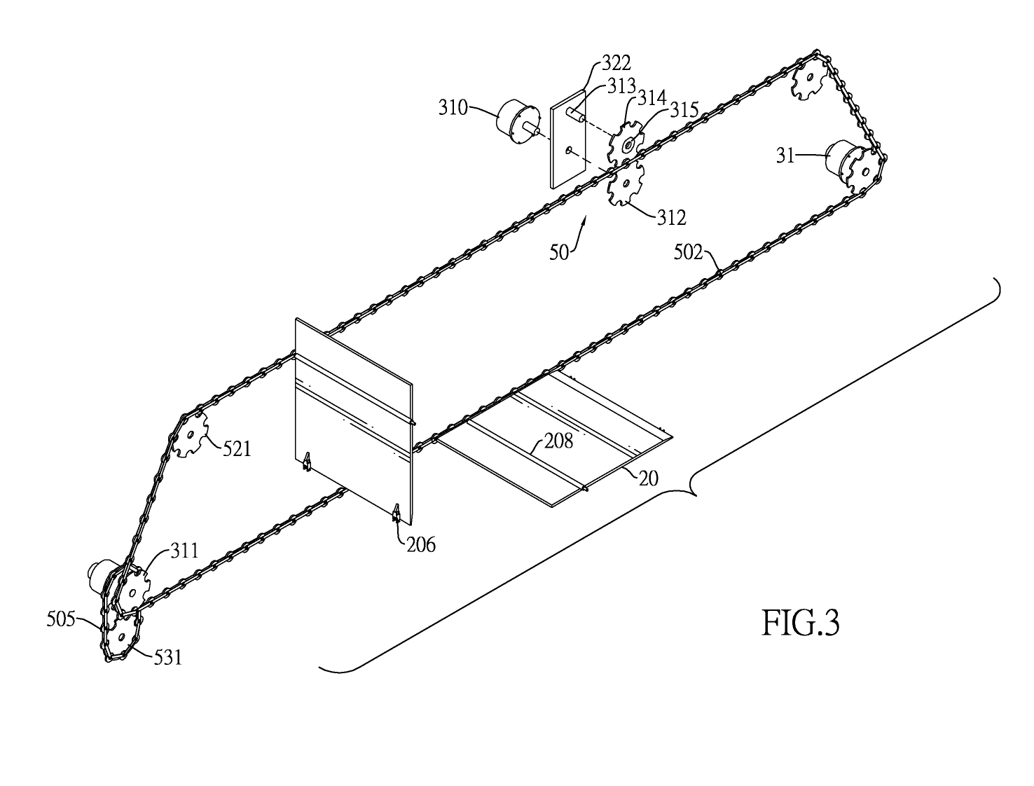

Furthermore, the driving devices may be connected with each other with a connecting device to make the driving devices moving simultaneously and synchronously. With reference to FIGS. 2 and 3, the connecting device comprises a connecting rod (501), two connecting wheels (531), two connecting chains (505) and two transmission wheels. The connecting rod (501) is mounted between the supporting panels (73) on one end of the base with two bearings (504). The connecting wheels (531) are mounted respectively on two ends of the connecting rod (501), and the transmission wheels are co-axially connected to the driving wheels (311) on the driving devices. Two connecting chains (505) are respectively mounted around the connecting wheels (531) and the transmission wheels. Accordingly, when the driving element (50) of one of the driving devices is moving, the driving element (50) of the other driving device will simultaneously and synchronously moved with the transmission of the connecting device.

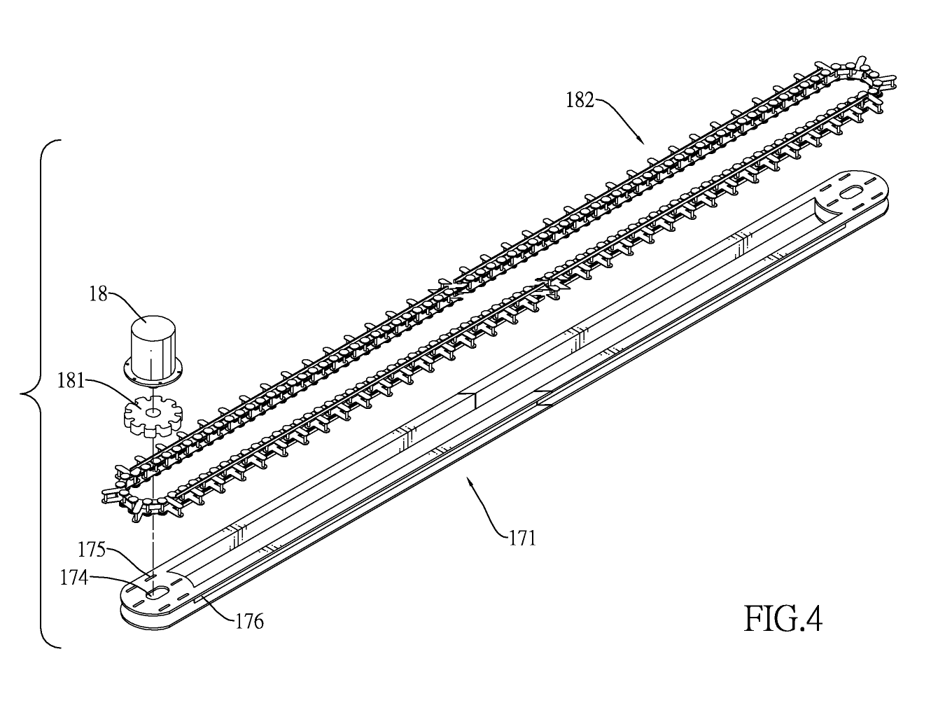

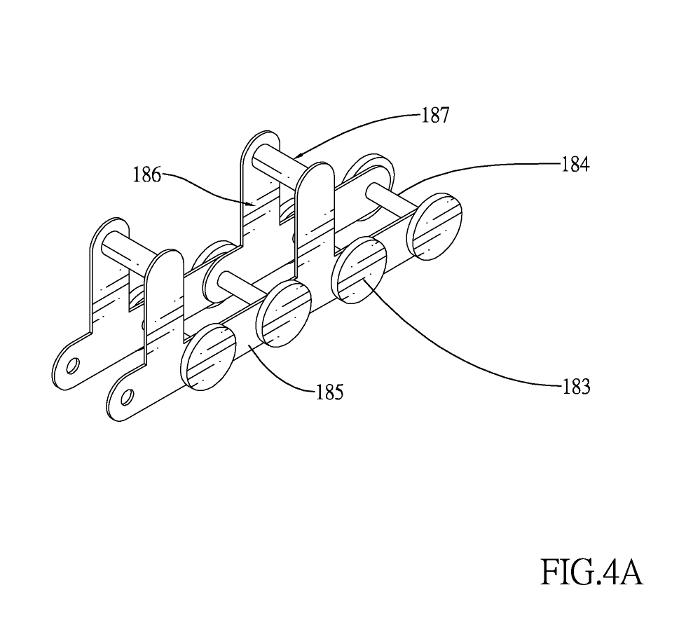

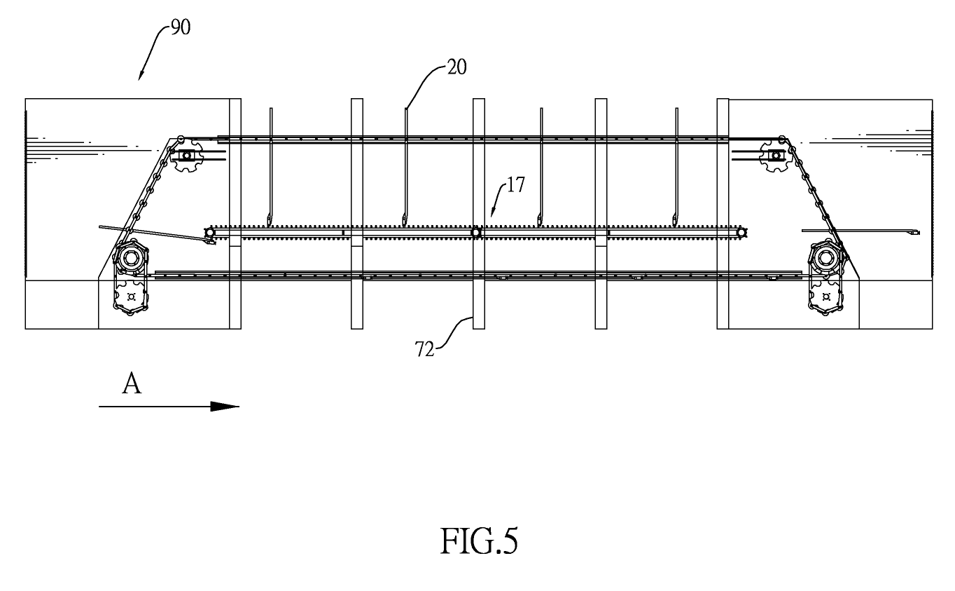

The chain assemblies (17) are mounted on the base parallel to the longitudinal directions of the driving devices, may be mounted in spaces defined between the side rods and lateral rods (722) of the doorframes (72) and correspond respectively to the driving devices. In the preferred embodiment, two chain assemblies (17) are implemented and correspond respectively to the driving devices. In an alternative embodiment, three or more chain assemblies (17) may be implemented. With reference to FIGS. 4, 5 and 10, each chain assembly (17) comprises at least one chain base (171) and at least one endless chain (182) respectively mounted around the at least one chain base (171). Each chain base (171) is elongated, may be hollow and mounted on the sliding brackets (75) at a same horizontal level and has two elongated shaft holes (174), multiple mounting holes (174) and a chain channel (176). The shaft holes (174) are defined respectively in two ends of the chain base (171). The mounting holes (175) are defined respectively in the ends of the chain base (171) and respectively around the shaft holes (174) and may be elongated. The chain channel (176) is defined around the chain base (171).

The at least one chain (182) of each chain assembly is connected with each other via the chain bases (171) as shown in FIG. 10. With further reference to 4A, each chain (182) is mounted slidably in the chain channel (176) in the corresponding chain base (171) and comprises multiple chain units connected with each other with pins (184) and multiple rotators (183). Each chain unit has two chain tabs (185) parallel to each other and a connection pin (187). Each chain tab (185) has an upward tab (186) formed on and protruding from the middle of the chain tab (185) and aligns with the upward tab (186) on the other chain tab. The connection pin (187) is mounted between the upward tabs (186). The rotators (183) are mounted on the chain units and are rotatably held in the chain channel (176) in the chain base (171).

With reference to FIGS. 10 and 10A, the blades (20) may be made of glass fibers, aluminum or any possible light material, may be rectangular, circular or in any possible shape and are connected to the driving elements (50) of the driving devices and the chains (182) of the chain assemblies at even intervals. In the preferred embodiment, ten blades (20) are implemented. Each blade (20) has a pivot (208) and two connectors (216). The pivot (208) is mounted on the blade (20) at a position near the top edge and away from the middle of the blade (20) and has two ends protruding respectively from two sides of the blade (20) and connected respectively to the driving elements (50) of the driving devices. In practice, the pivot (208) can serve as a pivot for connecting two chain units of the driving element (50). The ends of the pivot (208) may be respectively mounted through the pivot holes (506) in the corresponding chain units of the driving devices and may be threaded and screwed with nuts. With the position of the pivot (208) on the blade (20), the area between the pivot (208) and the bottom edge is larger that that between the pivot (208) and the top edge.

With further reference to FIG. 4A, the connectors (216) are mounted on the bottom edge of the blade (20) and detachably and respectively engage the chains (182) of the chain assemblies. Each connector (216) has two hooks (205) mounted on the bottom of the connector (216), detachably engages the chain (182) of the corresponding chain assembly and may detachably engage one of the connection pins (187) on the corresponding chain (182). Preferably, the hooks (205) may be retractably mounted on the bottom of the connector (216) with cylinders, threaded rod assembly or the like. Alternatively the hooks (205) may be integrally formed on the connector (216).

With reference to FIGS. 1 and 2, the fence assembly is mounted on the base and has two side fences (723) and a top fence (725). The side fences (723) are respectively mounted on two sides of the base and each side fence (723) comprises multiple fence panels mounted on the side rods of the doorframes (72). Each fence panel may be a shutter to close or open the space between the side rods of the corresponding doorframe (72) easily. The top fence (725) is mounted on the top of the base and comprises at least one fence panel mounted on the top lateral rods on the doorframes (72). The fence panel of the top fence (725) may be shutter to close or open the spaces between the top lateral rods of the doorframes (72) easily. Alternatively, the fence panel of the top fence (725) may be mounted securely on the top of the base to keep the spaces between the top lateral rods of the doorframes (72) always at a closed condition.

The turbulent flow chambers (90) are mounted respectively on two ends of the base and are respectively connected to the supporting panels (73). Each turbulent flow chamber (90) has a housing (903) attached to the corresponding supporting panels (73) and comprising an inner opening (902), an outer opening and a door (901). The inner opening (902) is defined in the housing (903) at an end corresponding to the supporting panels (73), communicates with the inner space in the base and has two sides respectively closed by the supporting panels (73). The outer opening is defined in the housing (903) at an end opposite to the base. The door (901) may be a shutter and is mounted in and closes or opens the outer opening.

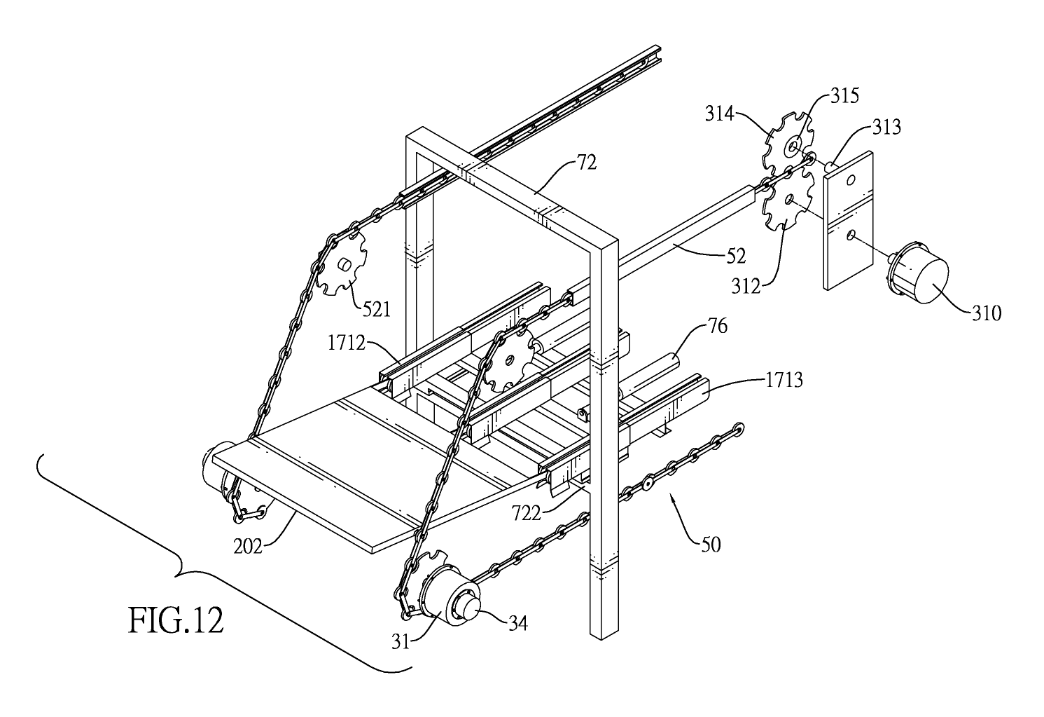

With reference to FIGS. 2, 3 and 4, the generating devices are connected to the driving devices and the chain assemblies to generate electrical power while the driving device and the chain assemblies are moving. With reference to FIG. 3, each generating device connected to the driving devices comprises a driving wheel (311,312) and a generator (31,310). The driving wheel (311,312) engages and is driven by the driving element (50) of the corresponding driving device. The driving wheel (311) may be served as the driving wheel (311) of the driving device. The generator (31,310) is connected to and driven by the driving wheel (311,312) to generate electrical power when the driving element (50) of the driving device is moving. Additionally, with further reference to FIG. 12, a generator mount (322) is mounted on one of the doorframes (72) of the base, and the upper track (52) has a gap defined in the upper track (52) and corresponding to each generator mount (322). The generator mount (322) may further comprise an auxiliary wheel (314) rotatably mounted on the generator mount (322) with an axle (313) and a bearing (315), and the auxiliary wheel (314) engages the driving element (50) of the driving device. The driving wheel (312) and the auxiliary wheel (314) on the generator mount (322) may be mounted respectively on two sides of the driving element (50) to make the driving element (50) driving the generator (310) via the driving wheel (312) actually and smoothly. Moreover, the auxiliary wheel (314) may be connected to another generator that is mounted on the generator mount (322) to improve of efficiency of the operation of the wind-powered device.

With reference to FIG. 4, each generating device connected to the chain assemblies comprises a driving wheel (181) and a generator (18). The driving wheel (181) is mounted rotatably in one end of the chain base (171) of a corresponding chain assembly and engages the chain (182) of the corresponding chain assembly. The generator (18) is mounted on the corresponding end of the chain base (171) with fasteners mounted through the generator (18) and the mounting holes (175). The generator (18) has a shaft mounted through the shaft hole (174) and connected to the driving wheel (181), such that the generator (18) is driven to generate electrical power by the driving wheel (181) when the chain (182) is moving. Additionally, with reference to FIG. 10, when each chain assembly is composed of more then two chain bases (171) that are connected with each other, two generating devices are co-axially mounted on and respectively at two sides of a conjunction of the adjacent chain bases (171).

With reference to FIGS. 1 and 2, the wind-powered device may further have an actuating device mounted on the base and connected to the driving devices for actuating the driving devices before the wind power is sufficient to push the blades (80) to move. The actuating device comprises multiple actuating motors (34) mounted on the supporting panels (73) and connected to the driving devices. Each actuating motor (34) may be co-axially mounted on one of the generators (31) that are connected to the driving devices.

With reference to FIGS. 1, 2, 5 and 10, the wind-powered device can be applied on a location having a fixed wind direction keeping a long time and the longitudinal direction of the base is arranged along a line against the wind direction A to gain a preferred operational efficiency.

In operation, the side fence (723) corresponding to a front side of the wind direction A is opened or removed, and the side fence (723) corresponding to a rear side of the wind direction is completely closed. The door (901) on the turbulent flow chamber (90) against the wind direction A is completely opened, and the door (901) on the other turbulent flow chamber (90) is completely or partially opened according to strength of the wind power. The actuating motors (34) are switched on to driven the driving elements (50) of the driving devices to move until the wind power achieving a desired level. At this time, the hooks (205) of the connectors (216) on the blades (20) are expanded to engage the chains (182) of the chain assemblies. With the movement of the driving elements (50), the blades (20) and the chains (182) are moved and some of the blades (20) are at a perpendicular condition relative to the wind direction A.

When the wind power achieves the desired level and is sufficient to pushes the blades (20), the actuating motors (34) are switched off and the blades (20) are pushed to move by the wind power. With the engagement between at least one of the hooks (205) on the connectors (216) with the chains (182), the blades (20) can be kept at the perpendicular condition against the wind direction A.

When the blades (20) move into the turbulent flow chamber (90) that is opposite to the wind direction A, the hooks (216) on the blades (20) will disengage from the chains (182) and the blade (20) will be push to a horizontal condition by the wind power. With the pivot (208) being connected with the driving elements (50) of the driving devices, the blades (20) in the horizontal condition will move with the driving elements (50) to the turbulent flow chamber (90) that is against the wind direction A.

When the blades (20) move into the turbulent flow chamber (90) that is against the wind direction A, the blades (20) will be pushed to the perpendicular condition by the wind power again and the connectors (216) on the blades (20) will reengage the chains (182) again. Consequently, the chains (182), the blades (20) and the driving elements (50) of the driving devices will be moved endlessly by the wind power, and the wind power can be efficiently transferred into mechanical power. Accordingly, the generators (18,31,310) of the generating devices are driven to generate electrical power with the endless movements of the driving elements (50) and the chains (182).

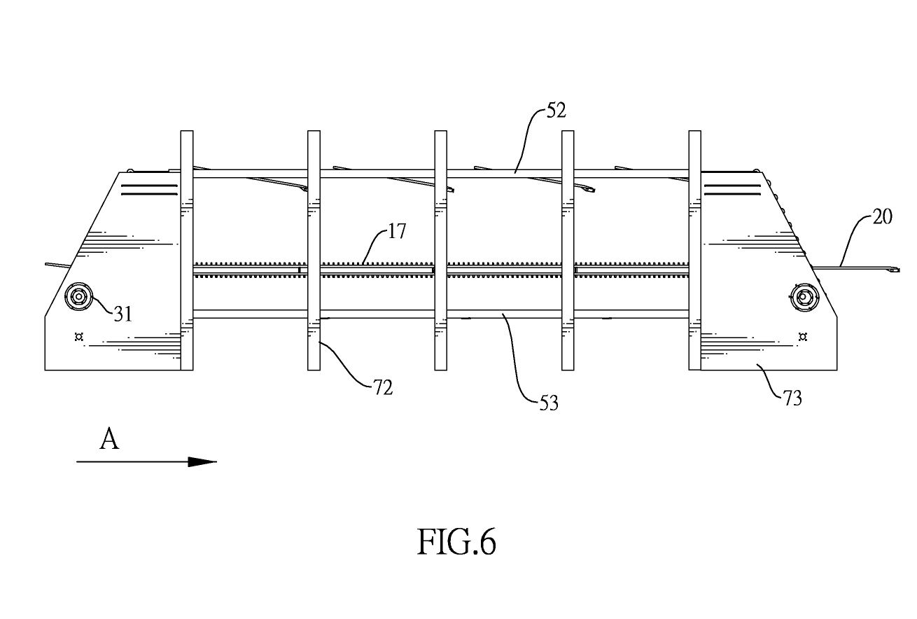

With reference to FIGS. 2, 6, 10 and 10A, when the wind power is larger than a desired level, the hooks (205) of the connectors (216) may be retracted to disengage from the chains (182) and the sliding brackets (75) are moved downward. The side fences (723) and the doors (901) are completely opened. Accordingly, the blades (20) will be pushed to a substantially horizontal condition along the wind direction A to prevent the blades (20) and the other components of the wind-powered devices from being damaged due to the excessive wind power.

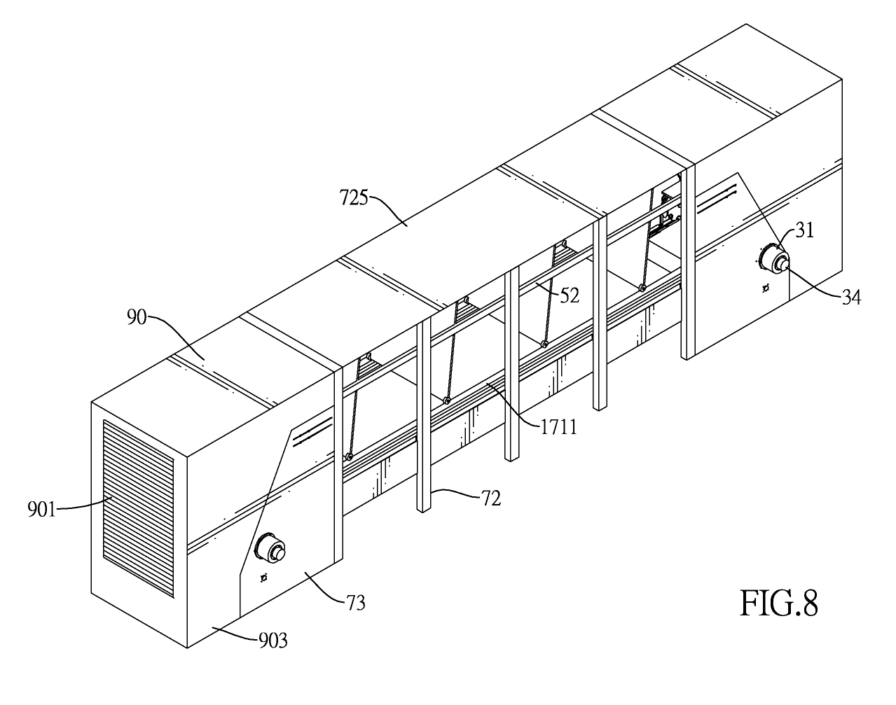

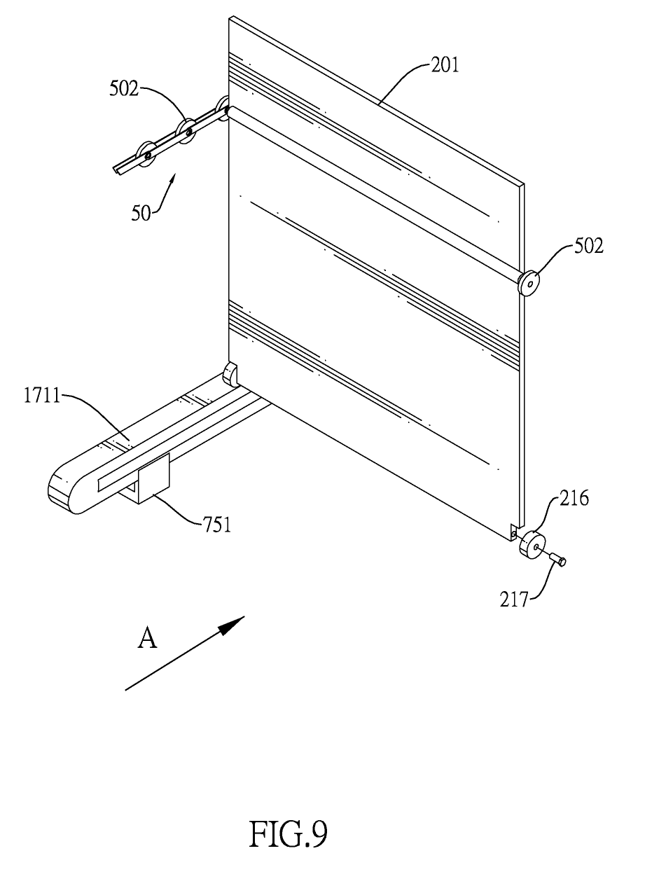

With reference to FIGS. 8 and 9, in a second embodiment of the wind-powered device, each blade (201) has two rotating wheels (216) rotatably mounted respectively at two ends of the bottom edge of the blade (201) with axles (217) and rotatably abutting respectively with two wheel tracks (1711). The wheel tracks (1711) are mounted in the base along the longitudinal directions of the driving devices and on paths of the rotating wheels (216) on the blades (201). Each wheel track (1711) has two curved ends and is mounted on the sliding brackets (7501) of the base. Accordingly, when the blades (201) are in the perpendicular condition, the rotating wheels (216) on the blades (201) abut with and rotate relative to the wheel tracks (1711). When the blades (201) move into the turbulent flow chamber (90) that is opposite to the wind direction, the wheels (216) will leave away from the wheel tracks (1711) and the blades (201) are pushed to a horizontal condition by the wind power.

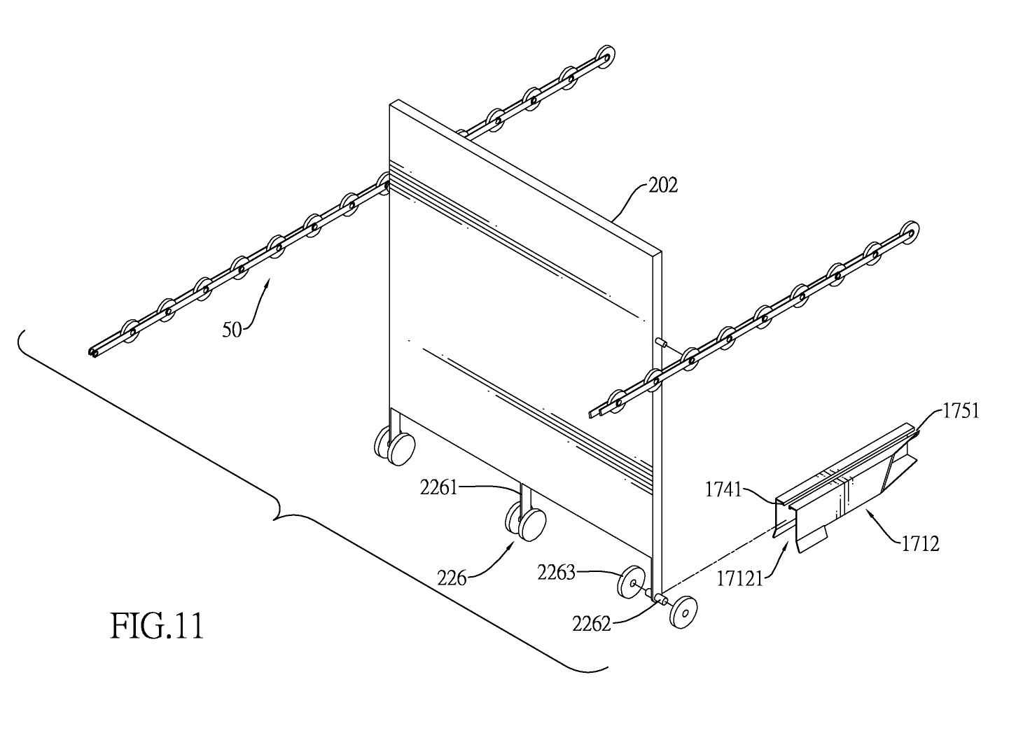

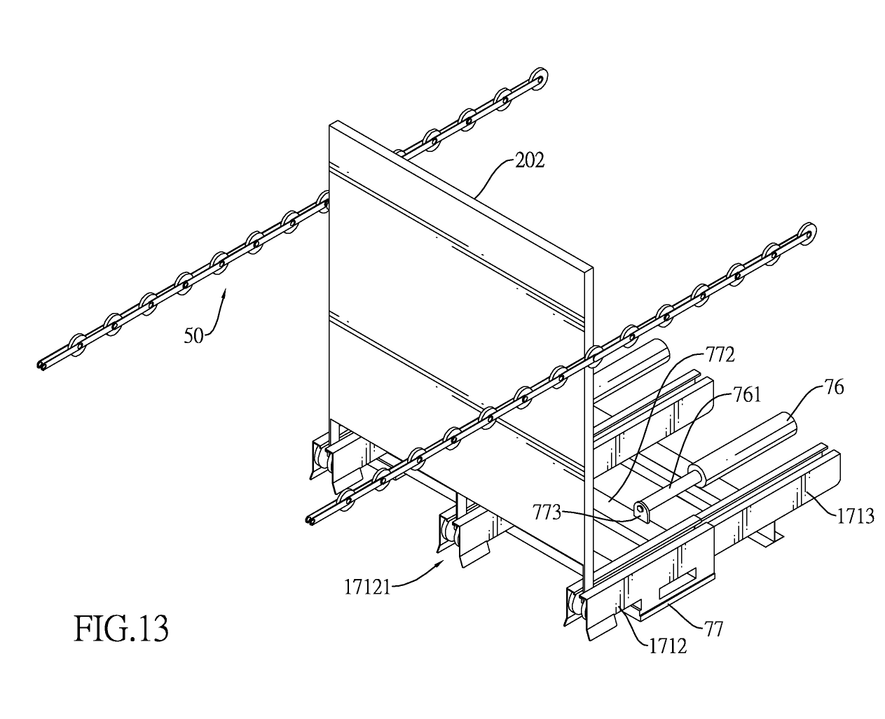

With reference to FIGS. 11 to 13, in the third embodiment of the wind-powered device, each blade (202) has multiple wheel assemblies (226) each composed of a wheel rod (2261) and two rotating wheels (2263). The wheel rod (2261) is mounted on and protrudes from the bottom edge of the blade (202) and has a wheel axle (2262) formed on and protruding from two sides of a free end of the wheel rod (2261) opposite to the blade (202). The rotating wheels (2263) are mounted rotatably on the ends of the wheel axle (2262).

The base further has multiple wheel tracks mounted along the longitudinal directions of the driving devices on a path of the wheel assemblies (226) on the blades (202) and corresponding to and holding the rotating wheels (2263) of the wheel assemblies (226) on the blades (202) rotatably inside. In the preferred embodiment, three wheel assemblies (226) and three wheel tracks are implemented. Each wheel track is composed of a central track element (1713) and two end track elements (1712) respectively mounted around two ends of the central track element (1713). The wheel track has a wheel channel defined in and along the wheel track and into which the wheel rod (2261) of the corresponding wheel assembly (226) extends, and the rotating wheels (2263) of the corresponding wheel assembly (226) abut rotatably with the inner surface of the wheel channel. The wheel channel has an opening (1751) defined in the top of the wheel track, such that two blocking tabs (1714) are formed on a top of the track element (1713,1712) respectively at two sides of the opening (1715) of the wheel channel. Each end track element (1712) may further have an enlarged guiding notch (17121) defined in the bottom at one end of the end track element (1712). Additionally, the base further has two track mounts (772) mounted slidably on the base and respectively connected to the end track elements (1712) on two ends of the wheel tracks. Each track mount (772) has multiple sliding mounts (77) formed on and protruding from the track mount (772) and connected to the corresponding end track elements (1712). Two cylinders (76) are mounted on the base and are connected respectively to the track mounts (772) to move the track mounts (772) and the end track elements (1712) respectively relative to the base and the central track elements (1713). Each cylinder (76) is mounted on the lower lateral rod (722) of one of the doorframes (72) on the base and has an expanding rod (761) expendably mounted on the cylinder (76) and connected to a rod tab (773) mounted on the corresponding track mount (772).

In use, when the wind power is under a desired level and the actuating motors (34) are switched on, the expanding rod (761) is expanded from the cylinder (76) to move the guiding notch (17121) on the end track element (1712) to a position where corresponds to a path of the rotating wheels (2263) on the blades (202). Accordingly, the wheels (2263) on the blades (202) can be easily guided into the wheel channels in the wheel tracks via the enlarged guiding notches (17121) in the end track elements (1712) when the blades (20) are moved with the driving devices.

When the wind power is at a desired level that can push the blades (20) to move, the rotating wheels (2263) are also guided into the wheel channels in the wheel track via the enlarged guiding notches (17121). With the rotating wheels (2263) being held in the wheel channels and the arrangement of the blocking tabs (1714), the rotating wheels (2263) are kept from escaping from the wheel tracks. Consequently, the top and bottom segments of the blades (202) can be held on the wheel tracks and the driving elements (50) of the driving devices, such that the movement of the blades (202) is smooth. The weight of the blades (202) can be effectively reduced to improve of the operation of the wind-powered device.

When the wind power is over the desired level, the expanding rod (761) is retracted into the cylinder (76) to move the end track elements (1712) leaving from the path of the rotating wheels (2263) on the blades (202). Accordingly, the rotating wheels (2263) on the blades (202) can be kept from entering to the wheel channels in the wheel tracks, and the blades (202) can be pushed to a horizontal condition along the wind direction with the excessive wind power.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wind-powered device comprising
at least one endless driving device having a longitudinal direction; and
at least one blade connected to the at least one driving device; and
at least one chain assembly mounted parallelly to the longitudinal direction of the at least one endless driving device, and each one of the at least one chain assembly having an endless chain detachably connected to and driven by the at least one blade, whereby the at least one endless driving device and the chain of the at least one chain assembly are driven by the at least one blade with wind power to transfer the wind power into a mechanical power and connected with a generating device.

2. The wind-powered device as claimed in claim 1, wherein the wind-powered device has two driving devices, two chain assemblies and multiple blades and further has a base on which the driving devices, the chain assemblies and the blades are mounted;
the driving devices are mounted respectively around the chain assemblies;
each chain assembly has
a chain base having a chain channel defined around the chain base to mount the chain of the chain device in the chain channel; and
two driving wheels connected respectively to two generators, respectively mounted rotatably on two ends of the chain base and around which the chain of the chain assembly is mounted; and
each blade has
a pivot mounted on a position away from a middle of the blade and connected to the driving devices; and
at least one connector mounted on the blade and detachably engaging the chain of a corresponding chain assembly.

3. The wind-powered device as claimed in claim 2 further comprising a connecting device having a connecting rod mounted between the driving devices to make the driving devices moving simultaneously and synchronously, wherein the connecting rod is connected to a generator and an actuating motor.

4. The wind-powered device as claimed in claim 3 further comprising multiple generators connected to the driving devices, wherein the base further has
multiple generator mounts mounted on the base and on which the generators are respectively mounted, and each generator mount having
a driving wheel connected to the corresponding generator; and
an auxiliary wheel rotatably mounted on the generator mount with an axle and a bearing and engaging the driving element of a corresponding driving device, wherein the driving wheel and the auxiliary wheel on the generator mount are mounted respectively on two sides of the corresponding driving element.

5. The wind-powered device as claimed in claim 4, wherein each driving device comprises an upper track mounted on the base along the longitudinal direction of the driving device;
a lower track mounted on the base along the longitudinal direction of the driving device and parallel to the upper track;
multiple driving wheels corresponding respectively to the tracks; and
an endless driving element mounted the driving wheels and slidably in the tracks.

6. The wind-powered device as claimed in claim 5, wherein the driving element of each driving device comprises multiple chain units connected each other, and each chain unit has
two chain tabs parallel to each other;
two pivot holes defined respectively in two ends of the chain unit; and
multiple pivots mounted through the pivot holes of the chain units to form the driving element as a chain; and
a rotator is mounted between each pair of adjacent chain units; and
one end of the pivot of each blade is mounted through on of the pivot holes in a corresponding driving element.

7. The wind-powered device as claimed in claim 6, wherein the connecting device further has
two connecting wheels mounted respectively on two ends of the connecting rod;
two transmission wheels co-axially connected to two of the driving wheels on the driving devices; and
two connecting chains respectively mounted around the connecting wheels and the transmission wheels.

8. The wind-powered device as claimed in claim 7, wherein
the base further comprises four supporting panels mounted on two ends of the base and arranged in parallel to each other, and each supporting panel having
two slots defined through the supporting panel;
a wheel mount mounted on the supporting panel at a side facing to a corresponding supporting panel and comprising an axle connected to one of the driving wheels of a corresponding driving device.

9. The wind-powered device as claimed in claim 8, wherein
the base has
multiple doorframes separately arranged along the base; and
multiple sliding brackets slidably mounted on the doorframes and connected to the chain assemblies; and
the blades are arranged at even intervals, and each blade has at least one hook detachably engaging a corresponding chain assembly.

10. The wind-powered device as claimed in claim 9, wherein each chain assembly comprises more than one chain base connected with each other and more than one endless chain respectively mounted around the chain bases and connected to each other via the chain bases; and
the chain bases are mounted on the sliding brackets at a same horizontal level.

11. The wind-powered device as claimed in claim 10, wherein each chain of each chain assembly comprises multiple chain units connected with each other, and each chain unit has
two upward tabs formed on and protruding from a middle of the chain unit chain tab; and
a connection pin mounted between the upward tabs to detachably engage one of the at least one hook on a corresponding blade;

12. The wind-powered device as claimed in claim 11, wherein the chain units of each chain of each chain assembly are connected with each other with pins, and each chain unit comprises
two chain tabs parallel to each other, wherein the upward tabs are formed on and protrude from middles of the chain tabs;
multiple rotators mounted on the chain units and are rotatably held in the chain channel in a corresponding chain base.

13. The wind-powered device as claimed in claim 11, wherein the base further has two turbulent flow chambers mounted on two ends of the base.

14. The wind-powered device as claimed in claim 13, wherein each turbulent flow chamber has
a housing attached to one end of the base and comprising an inner opening defined in the housing at an end corresponding to the corresponding end of the base and communicating with an inner space in the base;
an outer opening defined in the housing at an end opposite to the base; and
a door mounted in the outer opening to close or open the outer opening.

15. The wind-powered device as claimed in claim 14, wherein each doorframe of the base has
two parallel side rods;
a top lateral rod mounted on and connected between tops of the parallel side rods; and
a bottom lateral rod mounted on and connected between middles of the parallel side rods; and
the driving devices and the chain assemblies are mounted in spaces defined between the side rods and lateral rods of the doorframes.

16. The wind-powered device as claimed in claim 15 further comprising two side fences respectively mounted on two sides of the base.

17. The wind-powered device as claimed in claim 9, wherein each chain of each chain assembly comprises multiple chain units connected with each other, and each chain unit has
two upward tabs formed on and protruding from a middle of the chain unit chain tab; and
a connection pin mounted between the upward tabs to detachably engage one of the at least one hook on a corresponding blade;

18. The wind-powered device as claimed in claim 17, wherein the chain units of each chain of each chain assembly are connected with each other with pins, and each chain unit comprises
two chain tabs parallel to each other, wherein the upward tabs are formed on and protrude from middles of the chain tabs;
multiple rotators mounted on the chain units and are rotatably held in the chain channel in a corresponding chain base.

19. The wind-powered device as claimed in claim 18, wherein the base further has two turbulent flow chambers mounted on two ends of the base.

20. The wind-powered device as claimed in claim 19, wherein each turbulent flow chamber has
a housing attached to one end of the base and comprising an inner opening defined in the housing at an end corresponding to the corresponding end of the base and communicating with an inner space in the base;
an outer opening defined in the housing at an end opposite to the base; and
a door mounted in the outer opening to close or open the outer opening.

21. The wind-powered device as claimed in claim 20, wherein each doorframe of the base has
two parallel side rods;
a top lateral rod mounted on and connected between tops of the parallel side rods; and
a bottom lateral rod mounted on and connected between middles of the parallel side rods; and
the driving devices and the chain assemblies are mounted in spaces defined between the side rods and lateral rods of the doorframes.

22. The wind-powered device as claimed in claim 21 further comprising two side fences respectively mounted on two sides of the base.

23. A wind-powered device comprising
at least one endless driving device having a longitudinal direction; and
at least one blade connected to the at least one driving device and each one of the at least one blade having multiple rotating wheels mounted on a position away from a conjunction between the blade and the at least one driving device; and
at least one wheel track mounted parallelly to the longitudinal direction of the at least one endless driving device and abutting with the wheels on the blades, whereby the at least one endless driving device is driven by the at least one blade with wind power to transfer the wind power into a mechanical power and connected with a generating device.

24. The wind-powered device as claimed in claim 23, wherein the wind-powered device has two driving devices, two wheel tracks and multiple blades and further has a base on which the driving devices, the wheel tracks and the blades are mounted;
each blade has a pivot mounted on a position away from a middle of the blade and connected to the driving devices, wherein the wheels are mounted on the blade at a position away from the pivot;
the wheel tracks are mounted on paths of the rotating wheels on the blades and each has two curved ends;
the driving devices are mounted respectively around the wheel tracks.

25. The wind-powered device as claimed in claim 24 further comprising a connecting device having a connecting rod mounted between the driving devices to make the driving devices moving simultaneously and synchronously, wherein the connecting rod is connected to a generator and an actuating motor.

26. The wind-powered device as claimed in claim 25 further comprising multiple generators connected to the driving devices, wherein the base further has
multiple generator mounts mounted on the base and on which the generators are respectively mounted, and each generator mount having
a driving wheel connected to the corresponding generator; and
an auxiliary wheel rotatably mounted on the generator mount with an axle and a bearing and engaging the driving element of a corresponding driving device, wherein the driving wheel and the auxiliary wheel on the generator mount are mounted respectively on two sides of the corresponding driving element.

27. The wind-powered device as claimed in claim 26, wherein each driving device comprises
an upper track mounted on the base along the longitudinal direction of the driving device;
a lower track mounted on the base along the longitudinal direction of the driving device and parallel to the upper track;
multiple driving wheels corresponding respectively to the tracks; and
an endless driving element mounted the driving wheels and slidably in the tracks.

28. The wind-powered device as claimed in claim 27, wherein the driving element of each driving device comprises multiple chain units connected each other, and each chain unit has
two chain tabs parallel to each other;
two pivot holes defined respectively in two ends of the chain unit; and
multiple pivots mounted through the pivot holes of the chain units to form the driving element as a chain; and
a rotator is mounted between each pair of adjacent chain units; and
one end of the pivot of each blade is mounted through on of the pivot holes in a corresponding driving element.

29. The wind-powered device as claimed in claim 28, wherein the connecting device further has
two connecting wheels mounted respectively on two ends of the connecting rod;
two transmission wheels co-axially connected to two of the driving wheels on the driving devices; and
two connecting chains respectively mounted around the connecting wheels and the transmission wheels.

30. The wind-powered device as claimed in claim 29, wherein
the base further comprises four supporting panels mounted on two ends of the base and arranged in parallel to each other, and each supporting panel having
two slots defined through the supporting panel;
a wheel mount mounted on the supporting panel at a side facing to a corresponding supporting panel and comprising an axle connected to one of the driving wheels of a corresponding driving device.

31. The wind-powered device as claimed in claim 30, wherein
the base has
multiple doorframes separately arranged along the base; and
multiple sliding brackets slidably mounted on the doorframes and connected to the chain assemblies; and
the blades are arranged at even intervals, and each blade has at least one hook detachably engaging a corresponding chain assembly.

32. The wind-powered device as claimed in claim 31, wherein the base further has two turbulent flow chambers mounted on two ends of the base.

33. The wind-powered device as claimed in claim 32, wherein each turbulent flow chamber has
a housing attached to one end of the base and comprising an inner opening defined in the housing at an end corresponding to the corresponding end of the base and communicating with an inner space in the base;
an outer opening defined in the housing at an end opposite to the base; and
a door mounted in the outer opening to close or open the outer opening.

34. The wind-powered device as claimed in claim 33, wherein each doorframe of the base has
two parallel side rods;
a top lateral rod mounted on and connected between tops of the parallel side rods; and
a bottom lateral rod mounted on and connected between middles of the parallel side rods; and
the driving devices and the wheel tracks are mounted in spaces defined between the side rods and lateral rods of the doorframes.

35. The wind-powered device as claimed in claim 34 further comprising two side fences respectively mounted on two sides of the base.

36. A wind-powered device comprising
at least one endless driving device having a longitudinal direction;
at least one blade connected to the at least one driving device and each one of the at least one blade having a wheel assembly mounted on a position away from a conjunction between the blade and the at least one driving device, and each wheel assembly having a rotating wheel; and
at least one wheel track mounted parallelly to the longitudinal direction of the at least one endless driving device on a path of the wheel assemblies on the blades and holding the rotating wheels of the wheel assemblies on the blades rotatably inside, whereby the at least one endless driving device is driven by the at least one blade with wind power to transfer the wind power into a mechanical power and connected with a generating device.

37. The wind-powered device as claimed in claim 36, wherein the wind-powered device has two driving devices, multiple wheel tracks and multiple blades and further has a base on which the driving devices, the wheel tracks and the blades are mounted;
each wheel track comprises
a central track element;
two end track elements respectively mounted around two ends of the central track element; and
a wheel channel defined in and along the wheel track and in which the rotating wheels of the corresponding wheel assemblies on the blade are rotatably mounted and having an opening defined in the top of the wheel track;
the driving devices are mounted respectively around the wheel tracks; and
each blade has a pivot mounted on a position away from a middle of the blade and connected to the driving devices, wherein the at least one wheel assembly on each blade is mounted on the blade at a position away from the pivot.

38. The wind-powered device as claimed in claim 37 further comprising a connecting device having a connecting rod mounted between the driving devices to make the driving devices moving simultaneously and synchronously, wherein the connecting rod is connected to a generator and an actuating motor.

39. The wind-powered device as claimed in claim 38 further comprising multiple generators connected to the driving devices, wherein the base further has
multiple generator mounts mounted on the base and on which the generators are respectively mounted, and each generator mount having
a driving wheel connected to the corresponding generator; and
an auxiliary wheel rotatably mounted on the generator mount with an axle and a bearing and engaging the driving element of a corresponding driving device, wherein the driving wheel and the auxiliary wheel on the generator mount are mounted respectively on two sides of the corresponding driving element.

40. The wind-powered device as claimed in claim 39, wherein each driving device comprises
an upper track mounted on the base along the longitudinal direction of the driving device;
a lower track mounted on the base along the longitudinal direction of the driving device and parallel to the upper track;
multiple driving wheels corresponding respectively to the tracks; and
an endless driving element mounted the driving wheels and slidably in the tracks.

41. The wind-powered device as claimed in claim 40, wherein the driving element of each driving device comprises multiple chain units connected each other, and each chain unit has
two chain tabs parallel to each other;
two pivot holes defined respectively in two ends of the chain unit; and
multiple pivots mounted through the pivot holes of the chain units to form the driving element as a chain; and
a rotator is mounted between each pair of adjacent chain units; and
one end of the pivot of each blade is mounted through on of the pivot holes in a corresponding driving element.

42. The wind-powered device as claimed in claim 41, wherein the connecting device further has
two connecting wheels mounted respectively on two ends of the connecting rod;
two transmission wheels co-axially connected to two of the driving wheels on the driving devices; and
two connecting chains respectively mounted around the connecting wheels and the transmission wheels.

43. The wind-powered device as claimed in claim 42, wherein
the base further comprises four supporting panels mounted on two ends of the base and arranged in parallel to each other, and each supporting panel having
two slots defined through the supporting panel;
a wheel mount mounted on the supporting panel at a side facing to a corresponding supporting panel and comprising an axle connected to one of the driving wheels of a corresponding driving device.

44. The wind-powered device as claimed in claim 43, wherein each one of the central track element and the end track elements of each wheel track has two blocking tabs formed on a top of the track element respectively at two sides of the opening of the wheel channel to keep the corresponding rotating wheel from escaping from the wheel channel.

45. The wind-powered device as claimed in claim 44, wherein the end track elements of the wheel tracks are moveably relative to the central track elements along the longitudinal directions of the driving devices.

46. The wind-powered device as claimed in claim 45, wherein the base further has
two track mounts mounted slidably on the base and respectively connected to the end track elements on two ends of the wheel tracks, and each track mount having a rod tab mounted on the track mount; and
two cylinders mounted on the base and connected respectively to the track mounts, and each cylinder having an expanding rod expendably mounted on the cylinder and connected to the rod tab mounted on the corresponding track mount.

47. The wind-powered device as claimed in claim 46, wherein each end track element of each wheel track further has an enlarged guiding notch defined in the bottom at one end of the end track element.

48. The wind-powered device as claimed in claim 47, wherein the base further has two turbulent flow chambers mounted on two ends of the base.

49. The wind-powered device as claimed in claim 48, wherein each turbulent flow chamber has
a housing attached to one end of the base and comprising an inner opening defined in the housing at an end corresponding to the corresponding end of the base and communicating with an inner space in the base;
an outer opening defined in the housing at an end opposite to the base; and
a door mounted in the outer opening to close or open the outer opening.

50. The wind-powered device as claimed in claim 49, wherein
the base has multiple doorframes separately arranged along the base; and
each doorframe of the base has
two parallel side rods;
a top lateral rod mounted on and connected between tops of the parallel side rods; and
a bottom lateral rod mounted on and connected between middles of the parallel side rods; and
the driving devices and the wheel tracks are mounted in spaces defined between the side rods and lateral rods of the doorframes.

51. The wind-powered device as claimed in claim 50 further comprising two side fences respectively mounted on two sides of the base.
